(19) United States
(12) Patent Application Publication
(10) Pub. No.: US 2026/0202273 A1
(43) Pub. Date: Jul. 16, 2026

(54) SENSOR DEVICE

(71) Applicant: MINEBEA MITSUMI Inc., Kitasaku-gun, Nagano (JP)

(72) Inventors: Takamichi KITANO, Kitasaku-gun, Nagano (JP); Hiroaki MURAKAMI, Kitasaku-gun, Nagano (JP)

(21) Appl. No.: 19/135,562

(22) PCT Filed: Dec. 20, 2022
(86) PCT No.: PCT/JP2022/046951

§ 371 Date: Jun. 4, 2025

(51) Int. Cl. G01L 3/10

(52) U.S. Cl. CPC G01L 3/108

(57) ABSTRACT

A sensor device includes a bearing, a shaft (S) including a part supported by the bearing, a holder including a holding part for holding the bearing and a deformable surface extending in an axial direction of the bearing, a plurality of strain sensors for detecting information on a force (F′) acting on the shaft (S), a sensor for detecting information on a position of the shaft (S) in a circumferential direction of the bearing, and an arithmetic circuit, wherein the plurality of strain sensors are attached to the deformable surface, a signal output from the plurality of strain sensors and the sensor are input to the arithmetic circuit, and the arithmetic circuit calculates a magnitude (fᵣ) of a component (Fᵣ) in a radial direction of the bearing and a magnitude (fₜ) of a component (Fₜ) in the circumferential direction of the bearing, the components included in information on a force (F) applied to rotate the shaft (S) at a predetermined position of the shaft (S).

### TECHNICAL FIELD

The present invention relates to a sensor device.

### BACKGROUND ART

In the related art, for machines including a shaft rotating, a device for measuring a force applied to rotate the shaft is known. For example, Patent Literature 1 discloses a measuring device and measuring means for indicating the direction of a force in accordance with a crank angle in human-powered machines such as bicycles.

### CITATION LIST

### Patent Literature

Patent Document 1: WO 2012/053114

### SUMMARY OF INVENTION

### Technical Problem

In a machine including a shaft rotating, if information on a force for rotating the shaft can be calculated separately for a radial direction component and a circumferential direction component, there is a possibility that information useful in various types of analysis and control can be obtained. An example of an object of the present invention is to provide a sensor device capable of calculating information on a force for rotating a shaft separately for a radial direction component and a circumferential direction component.

### Solution to Problem

A sensor device according to the present invention includes a bearing, a shaft including a part supported by the bearing, a holder including a holding part for holding the bearing and a deformable surface extending in an axial direction of the bearing, a plurality of strain sensors for detecting information on a force acting on the shaft, a sensor for detecting information on a position of the shaft in a circumferential direction of the bearing, and
an arithmetic circuit, wherein the plurality of strain sensors are attached to the deformable surface,
signals output from the plurality of strain sensors and the sensor are input to the arithmetic circuit, and the arithmetic circuit calculates a magnitude of a component in a radial direction of the bearing and a magnitude of a component in the circumferential direction of the bearing, the components being included in information on a force for rotating the shaft at a predetermined position of the shaft in the circumferential direction of the bearing.

### BRIEF DESCRIPTION OF DRAWINGS

FIG. 1 is a block diagram schematically illustrating a configuration of a sensor device according to an embodiment being one example of the present invention.

FIG. 2 is a diagram illustrating an example of a relationship between a force for rotating a shaft and a radial direction component and a circumferential direction component of the shaft.

FIG. 3 is a diagram illustrating an example of a relationship between a force for rotating the shaft and a radial direction component and a circumferential direction component of the shaft.

FIG. 4 is a diagram illustrating an example of a relationship between a force for rotating the shaft and a radial direction component and a circumferential direction component of the shaft.

FIG. 5 is a diagram illustrating an example of a relationship between a force for rotating the shaft and a radial direction component and a circumferential direction component of the shaft.

FIG. 6 is a perspective view of a holder, strain sensors, and plate parts of a sensor device according to an embodiment being one example of the present invention.

FIG. 7 is a cross-sectional view of the sensor device according to the embodiment being one example of the present invention (however, an arithmetic circuit is omitted).

FIG. 8 is a cross-sectional view illustrating another example of the holder included in the sensor device according to the embodiment being one example of the present invention.

FIG. 9 is a cross-sectional view illustrating yet another example of the holder included in the sensor device according to the embodiment being one example of the present invention.

FIG. 10 is a cross-sectional view illustrating yet another example of the holder included in the sensor device according to the embodiment being one example of the present invention.

FIG. 11 is a plan view illustrating yet another example of the holder included in the sensor device according to the embodiment being one example of the present invention.

FIG. 12 is a cross-sectional view illustrating yet another example of the holder included in the sensor device according to the embodiment being one example of the present invention, and is a cross-sectional view corresponding to the A-A cross section in FIG. 11.

FIG. 13 is a plan view illustrating yet another example of the holder included in the sensor device according to the embodiment being one example of the present invention.

FIG. 14 is a cross-sectional view illustrating yet another example of the holder included in the sensor device according to the embodiment being one example of the present invention, and is a cross-sectional view corresponding to the B-B cross section in FIG. 13.

FIG. 15 is a perspective view illustrating yet another example of the holder included in the sensor device according to the embodiment being one example of the present invention.

FIG. 16 is a plan view illustrating yet another example of the holder included in the sensor device according to the embodiment being one example of the present invention.

FIG. 17 is a schematic view illustrating an application example of the sensor device according to an embodiment being one example of the present invention.

FIG. 18 is a schematic view illustrating another application example of the sensor device according to the embodiment being one example of the present invention.

### DESCRIPTION OF EMBODIMENTS

In the description of the embodiment of the present invention, a direction of arrow a along an X-axis (the central axis of a shaft S) is defined as an upper side or one side in the axial direction, for convenience of description. The direction of arrow b along the X axis is defined as a lower side or the other side in the axial direction. Here, the direction of arrows a-b is referred to as an up-down direction or an axial direction (axial direction of first bearings 202 and 602). However, the up-down direction does not necessarily coincide with a vertical direction. In addition, the direction of arrows c-d is referred to as a radial direction (radial direction of the first bearings 202 and 602), the direction of the arrow c extending away from the X axis is referred to as an outer side or one side in the radial direction, and the direction of the arrow d extending toward the X axis is referred to as an inner side or the other side in the radial direction. Further, the direction along a tangential line of a circle around the axis X (a direction perpendicular to the radial direction) is referred to as a tangential direction, and the direction rotating around the X axis is referred to as a circumferential direction (a circumferential direction of the first bearings 202 and 602).

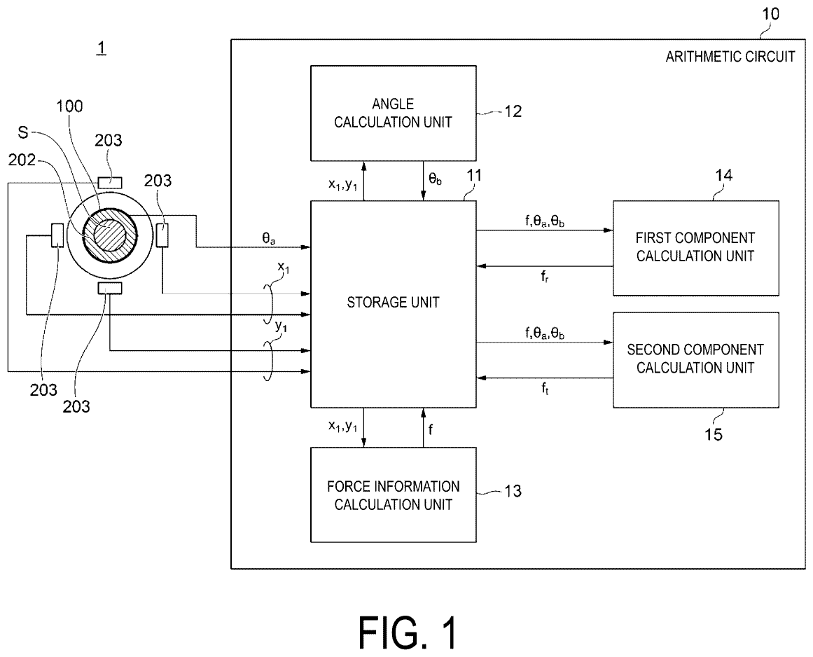

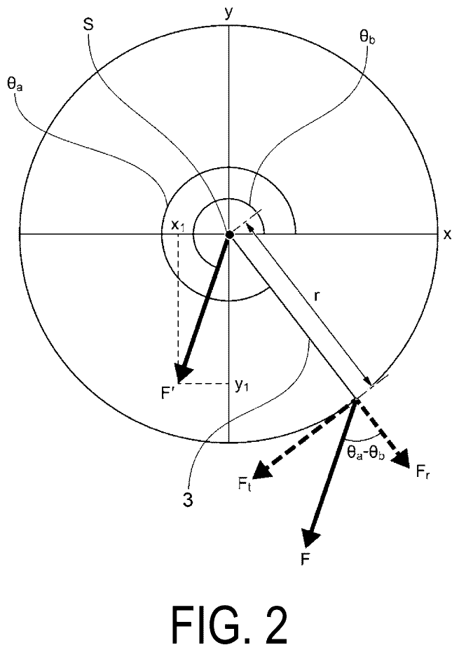

An embodiment being one example of the present invention will be described below with reference to the drawings. FIG. 1 is a block diagram schematically illustrating a configuration of a sensor device 1 according to the present embodiment. The sensor device 1 includes the first bearing 202, the shaft S including a part supported by the first bearing 202, a plurality of (four in the present embodiment) strain sensors 203, a sensor 100 configured to detect information on positions (rotation angles) of the shaft S in the circumferential direction of the first bearing 202, and an arithmetic circuit 10. FIGS. 2 to 5 are diagrams illustrating various examples of a relationship between a force F (applied) to rotate the shaft S and a radial direction component Fᵣ and a circumferential direction component Fₜ of the shaft. Note that, hereinafter, “force for rotating the shaft” indicates “force applied to rotate the shaft”. The “force for rotating the shaft” is a vector and may include a component of a force hardly contributing to the rotation of the shaft.

The plurality of strain sensors 203 are disposed to be able to detect components x₁ and y₁ in two orthogonal directions included in the information related to a force F′ in the radial direction acting on the shaft S. The force F′ is a force acting at the position of the shaft S via a member 3 (for example, a member such as a crank different from the shaft S or a pedal coupled to the shaft via the crank) connected to the shaft S when the force F is applied to the member 3 at a position away from the shaft S. Here, x₁ is a component of F′ in a direction along the x axis in FIGS. 2 to 5, and y₁ is a component of F′ in a direction along the y axis in FIGS. 2 to 5. x₁ and y₁ may be positive values or negative values. The specific arrangement and configuration of the plurality of strain sensors 203 will be described below. The plurality of strain sensors 203 output information corresponding to x₁ and y₁ as signals. The output signals are input to the arithmetic circuit 10.

Note that, for convenience of description, FIG. 1 illustrates that two of the plurality of (four) strain sensors 203 output information on x₁ as a signal and the other two output information on y₁ as a signal, but in practice, a strain detected by each of the plurality of strain sensors 203 does not need to correspond to only either x₁ or y₁. For example, the arithmetic circuit 10 having received an input of information on strains detected by each of the plurality of strain sensors 203 as a signal or another circuit (not illustrated) disposed at any position on the signal path between the plurality of strain sensors 203 and the arithmetic circuit 10 may be configured to integrate information on the strains detected by each of the plurality of strain sensors 203 and calculate x₁ and y₁.

The sensor 100 detects information on positions (rotation angles) of the shaft S in the circumferential direction. A specific configuration of the sensor 100 will be described below. The sensor 100 outputs information on a rotation angle θₐ of the shaft S with respect to a predetermined angle in the circumferential direction as a signal. Here, the rotation angle θₐ indicates the degree of counterclockwise rotation of the shaft S with respect to the positive direction of the x axis in FIGS. 2 to 5, and satisfies 0≤θₐ≤2π. The output signals are input to the arithmetic circuit 10. However, information on the rotation angle θₐ does not necessarily need to be output from the sensor 100, and the arithmetic circuit 10 or another circuit (not illustrated) disposed at any position on a signal path between the sensor 100 and the arithmetic circuit 10 may be configured to calculate the rotation angle θₐ, based on a signal output from the sensor 100.

The arithmetic circuit 10 is a program processing device (e.g., a micro controller) having a configuration with, for example, a processor such as a CPU and the like, various storage devices such as a RAM and a ROM, and peripheral circuits such as a counter (timer), an A/D conversion circuit, a D/A conversion circuit, a clock generation circuit, and an input/output I/F circuit being connected to each other via a bus or a dedicated line.

The arithmetic circuit 10 includes, for example, a storage unit 11, an angle calculation unit 12, a force information calculation unit 13, a first component calculation unit 14, and a second component calculation unit 15. The storage unit 11, the angle calculation unit 12, the force information calculation unit 13, the first component calculation unit 14, and the second component calculation unit 15 are implemented when the processor executes various types of arithmetic processing in accordance with the programs stored in a memory and controls the peripheral circuits such as the counter, the A/D conversion circuit, and the like in the program processing device serving as the arithmetic circuit 10, for example. Note that the arithmetic circuit 10 may have other functions.

Signals output from the plurality of strain sensors 203 and the sensor 100 are input to the arithmetic circuit 10. The storage unit 11 stores the input values of x₁, y₁, and θₐ. The angle calculation unit 12 refers to the values of x₁ and y₁ stored in the storage unit 11, calculates the angle θ_{b} of the direction of the force F with respect to a predetermined angle, and stores the value of θ_{b} in the storage unit 11. Here, Ob is an angle formed by the positive direction of the x axis in FIGS. 2 to 5 and the direction of the force F, and satisfies 0≤θ_{b}≤2π. θ_{b} can be calculated using, for example, the following Equation (1) when the force F′ acting in the radial direction on the shaft S is directed to an n-th quadrant in the coordinates illustrated in FIGS. 2 to 5. However, the method for obtaining θ_{b} is not limited to the method using Equation (1). Which quadrant of the coordinates the force F′ is directed to can be determined by whether the values of x₁ and y₁ are positive or negative.

$$\begin{matrix}[ Math 1 ] & \\ {θ}_{b} = \{ \begin{matrix}\frac{n - 1}{2} π + {tan}^{- 1} \frac{{y}_{1}}{{x}_{1}} , & n = 1 , 3 \\ \frac{n}{2} π + {tan}^{- 1} \frac{{y}_{1}}{{x}_{1}} , & n = 2 , 4\end{matrix} & ( 1 )\end{matrix}$$

The force information calculation unit 13 calculates the magnitude f of the force F with reference to the values of x₁ and y₁ stored in the storage unit 11 and the value of the distance r from the position receiving application of the force F to the shaft S, and stores the value (information) of f in the storage unit 11. For example, when the sensor device 1 is used for a bicycle, the force F is a pedaling force applied to a pedal, and r is a distance (a length of the crank) from the pedal to the shaft S (crankshaft). f can be calculated using, for example, the following Equation (2). However, the method for obtaining f is not limited to the method using Equation (2).

$$\begin{matrix}[ Math 2 ] & \\ f = \frac{1}{r} \sqrt{{x}_{1}^{2} + {y}_{1}^{2}} & ( 2 )\end{matrix}$$

The first component calculation unit 14 refers to the values of f, θₐ, and θ_{b} stored in the storage unit 11, calculates the magnitude fᵣ of the component Fᵣ of the force F in the radial direction, and stores the value (information) of fᵣ in the storage unit 11. fᵣ can be calculated using, for example, the following Equation (3). However, the method for obtaining fᵣ is not limited to the method using Equation (3).

$$\begin{matrix}[ Math 3 ] & \\ {f}_{r} = \vert f cos ( {θ}_{a} - {θ}_{b} ) \vert & ( 3 )\end{matrix}$$

The second component calculation unit 15 refers to the values of f, θₐ, and θ_{b} stored in the storage unit 11, calculates the magnitude fₜ of the component Fₜ of the force F in the circumferential direction, and stores the value (information) of fₜ in the storage unit 11. fₜ can be calculated using, for example, the following Equation (4). However, the method for obtaining fₜ is not limited to the method using Equation (4).

$$\begin{matrix}[ Math 4 ] & \\ {f}_{t} = \vert f sin ( {θ}_{a} - {θ}_{b} ) \vert & ( 4 )\end{matrix}$$

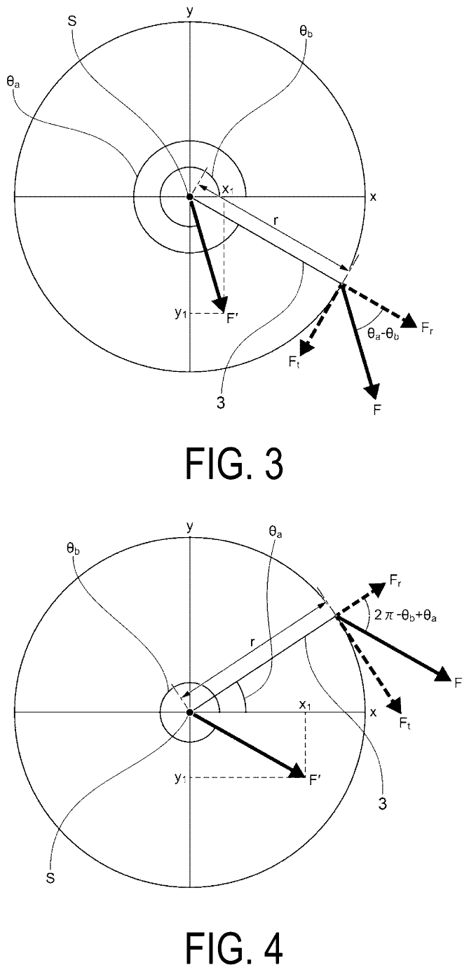

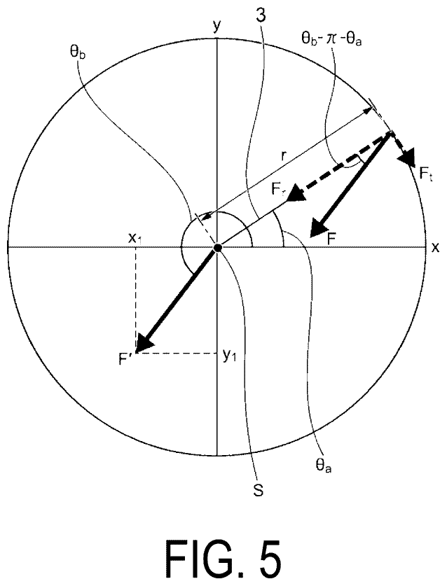

Here, the angle formed between the force F and the component Fᵣ is indicated by θₐ-θ_{b} in the examples of FIGS. 2 and 3, the angle formed between the force F and the component Fᵣ is indicated by 2π−θ_{b}+θₐ in the example of FIG. 4, and the angle formed between the force F and the component Fᵣ is indicated by θ_{b}−π−θₐ in the example of FIG. 5. Even in the above cases, since cos (2π−θ_{b}+θₐ)=cos (θₐ−θ_{b}), sin (2π−θ_{b}+θₐ)=sin (θₐ−θ_{b}) are established, and also cos (θ_{b}−π−θₐ)=−cos (θₐ−θ_{b}), and sin (θ_{b}−π−θₐ)=sin (θₐ−θ_{b}) are established, fᵣ and fₜ can be obtained using the above equations.

The method for calculating the magnitude fᵣ of the component Fᵣ in the radial direction and the magnitude fₜ of the component Fₜ in the circumferential direction of the force F described above is merely an example, and any calculation method may be used as long as correct values or approximate values of the components are obtained. The values (information) obtained by the calculation of the magnitude fᵣ of the component Fᵣ in the radial direction and the magnitude fₜ of the component Fₜ in the circumferential direction of the force F do not necessarily need to be strictly correct values, and may include an error within a range not interfering with actual use.

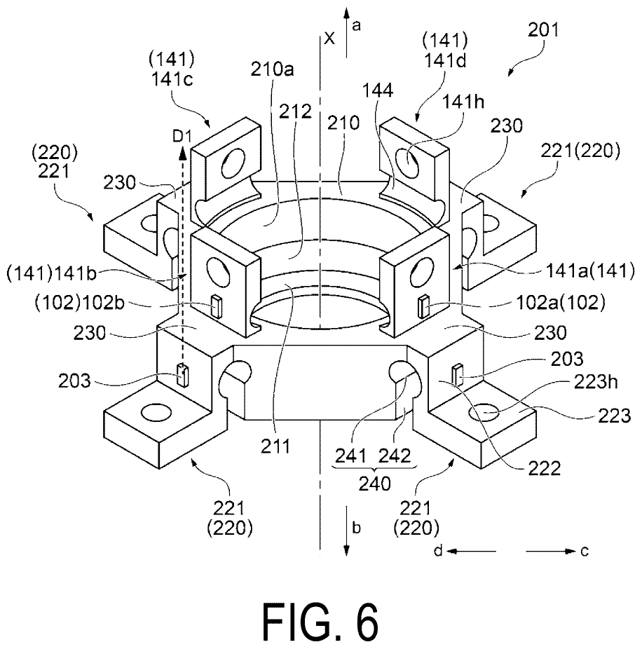

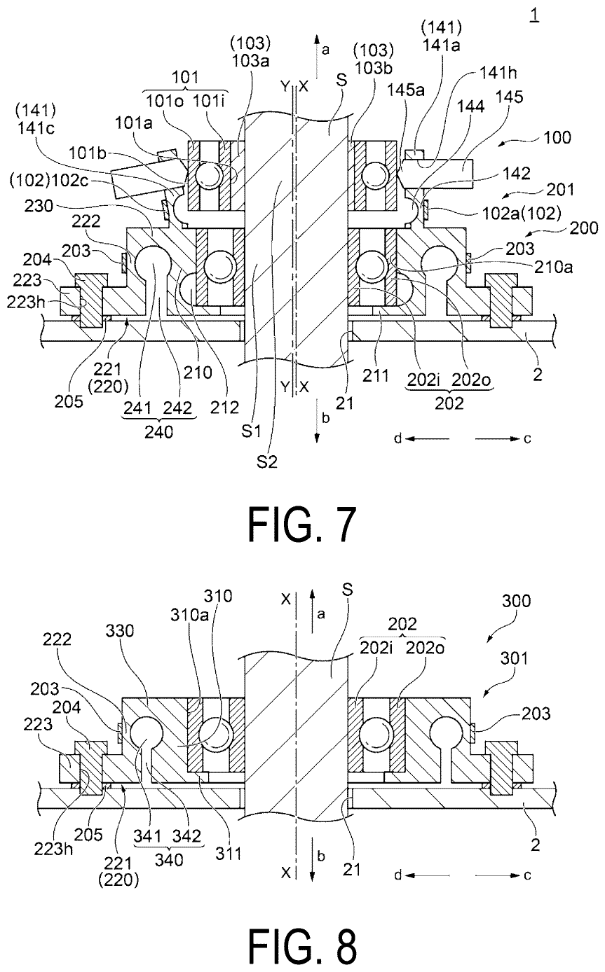

Hereinafter, a specific configuration of the sensor device 1 according to the present embodiment excluding the arithmetic circuit 10 will be described. FIG. 6 is a perspective view illustrating a part of the holder 201, the strain sensors 203, and the sensor 100 of the sensor device 1. FIG. 7 is a cross-sectional view of the sensor device 1 (however, the arithmetic circuit 10 is not illustrated).

The sensor device 1 includes the sensor 100 configured to detect information on positions (rotation angles) of the shaft S, and a torque sensor 200. The sensor 100 includes a second bearing 101 having an inner peripheral surface 101a and an outer peripheral surface 101b, and a strain gauge 102 attached to the outer peripheral surface 101b of the second bearing 101 via a plate part 141. The torque sensor 200 includes the first bearing 202 and the plurality of (four in the present embodiment) strain sensors 203.

In the present embodiment, the first bearing 202 is a ball bearing including an inner ring 202i, an outer ring 2020, and rolling elements. The second bearing 101 is a ball bearing including an inner ring 101i, an outer ring 1010, and rolling elements. Note that the first bearing 202 and the second bearing 101 are not limited to ball bearings, and various other bearings such as a sleeve bearing, for example, may be used. The second bearing 101 is disposed at one side (in the arrow a direction) of the first bearing 202 at an interval in the axial direction. The shaft S includes a part S1 supported by the first bearing 202 and a part S2 supported by the second bearing 101.

First, the torque sensor 200 will be described. As illustrated in FIG. 6, the holder 201 has a substantially square tubular shape in plan view, and includes a holding part 210 and an outer peripheral member 220. The holding part 210 is a member having an inner peripheral surface 210a having a cylindrical shape about the X axis, and having a tubular shape extending in the axial direction. The holding part 210 is a member holding the first bearing 202. The outer peripheral member 220 is a member disposed at one side (in the arrow c direction) in the radial direction with respect to the holding part 210.

In the axial direction, the dimension of the holding part 210 is the same as the dimension of the outer peripheral member 220. The end surface at one side in the axial direction (the arrow a direction) and the end surface at the other side in the axial direction (the arrow b direction) of the holding part 210 are on the same plane as the end surface at one side in the axial direction (the arrow a direction) and the end surface at the other side in the axial direction (the arrow b direction) of the outer peripheral member 220. At the end parts of the holding part 210 at one side in the radial direction (the arrow c direction) and at one side in the axial direction (the arrow a direction), four connection parts 230 having a substantially rectangular shape in plan view protrude radially from the holding part 210 toward one side in the radial direction (the arrow c direction). The four connection parts 230 are disposed at rotationally symmetric positions overlapping when rotated by 90° about the X axis (hereinafter referred to as “four-fold symmetry”). The connection parts 230 connect the holding part 210 and a deformable surface 222 to be described below.

A flexure elements 221 having a rectangular shape in plan view and a substantially L-shape in a side view is connected to each of the connection parts 230. The flexure elements 221 are deforming parts deformed by receiving stress, and are elastically deformed or plastically deformed by receiving stress. The four flexure elements 221 form the outer peripheral member 220 in the present embodiment. Since all the four flexure elements 221 have the same configuration, only one flexure element 221 will be described in detail below, while detailed description of the other flexure elements 221 will be omitted.

The flexure element 221 (outer peripheral member 220) has a deformable surface 222 extending in the axial direction. The holder 201 includes a gap 240, to be described later, between the deformable surface 222 and the holding part 210 on the first bearing 202 side with respect to the deformable surface 222. Due to the shape of the gap 240, the deformable surface 222 has a smaller thickness (thickness in the radial direction) than other parts of the flexure element 221 (outer peripheral member 220), and deformation with a strain is likely to occur.

As illustrated in FIG. 7, in the radial direction, the flexure element 221 (outer peripheral member 220) opposes the holding part 210 across the gap 240 extending in the tangential direction or the circumferential direction. The gap 240 includes a through hole (hole part) 241 having a circular or substantially circular cross-section, and a slit 242 connected to the through hole 241. The slit 242 is connected to the through hole 241 at a position on the other side in the axial direction (the arrow b direction) and closer to the other side in the radial direction (the arrow d direction). In addition, the width (width in the radial direction) of the slit 242 is narrower than the outer shape (diameter) of the through hole 241.

Since the through holes 241 are formed, the flexure element 221 (outer peripheral member 220) is formed with a recess part recessed toward one side in the radial direction (the arrow c direction) on the surface at the other side in the radial direction (the arrow d direction), the connection part 230 is formed with a recess part recessed toward one side in the axial direction (the arrow a direction) on the surface at the other side in the axial direction (the arrow b direction), and the holding part 210 is formed with a recess part recessed toward the other side in the radial direction (the arrow d direction) on the surface at one side in the radial direction (the arrow c direction).

Since each flexure element 221 has the deformable surface 222, the holder 201 of the torque sensor 200 has a plurality of (four in the present embodiment) deformable surfaces 222 as a whole. The plurality of deformable surfaces 222 are disposed side by side in the circumferential direction at the positions of four-fold symmetry (rotational symmetry) (FIG. 6).

The strain sensor 203 is attached to one side of the deformable surface 222 in the radial direction (the arrow c direction). Since the strain sensor 203 is attached to each of the plurality of deformable surfaces 222, a plurality of (four in the present embodiment) strain sensors 203 are attached to the torque sensor 200. Directions of strains detected by the respective strain sensors 203 are different from each other. The deformable surfaces 222 and the strain sensors 203 each extend along a plane parallel to the axial direction. The strain sensors 203 are attached so as to be capable of detecting a strain of the deformable surfaces 222. Thus, the strain sensor 203, when being a strain gauge, is attached to the deformable surface 222 so as to align a grid orientation (typically, the longitudinal direction of the strain gauge) to the axial direction (see arrow D1 in FIG. 6). Note that the grid orientation of the plurality of strain sensors 203 is not limited to the axial direction, and may be a direction oblique to the axial direction. Alternatively, the grid orientation of two strain sensors 203 opposing each other among the plurality of strain sensors may be the axial direction, and the orientation of the other two strain sensors 203 opposing each other may be the circumferential direction. Alternatively, the grid orientation of the two strain sensors 203 opposing each other may be a direction (first direction) oblique to the axial direction, and the orientation of the other two strain sensors 203 opposing each other may be a direction (second direction) oblique to the axial direction and a different direction, such as a direction intersecting the first direction. When the strain sensor 203 is a strain gauge, a strain of the deformable surface 222 is detected as a change in a resistance value. Note that the strain sensor 203 is not limited to a strain gauge, and may be various other types of sensor such as a piezoelectric element.

A fixing part 223 to be connected to an external device 2 is disposed at one side (the arrow c direction) of the flexure element 221 in the radial direction with respect to the deformable surface 222. The fixing part 223 is a plate-like part having a square shape extending toward one side of the deformable surface 222 in the radial direction (the arrow c direction) from the end part of the deformable surface 222 at the other side in the axial direction (the arrow b direction). A through hole (hole part) 223h having a circular shape is formed in the vicinity of the central part of the fixing part 223. Bolts 204 inserted into the through holes 223h fix the flexure elements 221 to the external device 2 via a spacer 205. Thus, the holder 201 is entirely fixed to the external device 2.

The first bearing 202 is disposed at the other side of the holding part 210 of the holder 201 in the radial direction (the arrow d direction). The first bearing 202 is held by the holding part 210 of the holder 201. An inner ring 202i of the first bearing 202 is adhered or press-fitted to the outer peripheral surface (surface at one side in the radial direction) of a part S1 of the shaft S having a columnar shape, the part being supported by the first bearing 202. Thus, the inner ring 202i of the first bearing 202 is fixed to the shaft S. An outer ring 2020 of the first bearing 202 is press-fitted to the inner peripheral surface 210a of the holding part 210 of the holder 201. The first bearing 202 rotatably supports the shaft S with respect to the holder 201. The end part of the shaft S at the other side in the axial direction (the arrow b direction) protrudes from a through hole (hole part) 21 of the external device 2 to the outside of the external device 2.

The holder 201 includes a contact part 211 having an annular shape and protruding toward the other side in the radial direction (the arrow d direction), at an end part at the other side in the axial direction (the arrow b direction). In the present embodiment, the contact part 211 protrudes from the holding part 210 of the holder 201 toward the other side in the radial direction (the arrow d direction). The contact part 211 is in contact with the end surface of the outer ring 2020 of the first bearing 202 at the other side in the axial direction (the arrow b direction). As a result, the contact part 211 supports the first bearing 202 while restricting downward movement in the axial direction.

A recess part 212 having a semicircular shape or a substantially semicircular shape in a cross-sectional view and recessed toward one side in the radial direction (the arrow c direction) is formed in the vicinity of the end part of the inner peripheral surface 210a of the holding part 210 at the other side in the axial direction (the arrow b direction). The recess part 212 is formed in an annular shape about the X axis at one side of the contact part 211 in the axial direction (the arrow a direction). The end part of the recessed surface of the recess part 212 at the other side in the axial direction (the arrow b direction) is smoothly connected to the end surface of the contact part 211 at one side in the axial direction (the arrow a direction).

When the sensor device 1 is used for a bicycle, the shaft S is a crankshaft with a crank (crank arm) and pedals connected. When one of the pedals is stepped, a force acts on the shaft S on the pedal side to cause the shaft S to incline downward in the vertical direction, thus the first bearing 202 tends to move in the radial direction, and a part of the holder 201 is pressed toward one side in the radial direction (the arrow c direction). In the holder 201, stress is likely to concentrate on the deformable surface 222 of the flexure element 221, causing deformation with a strain to occur at the deformable surface 222.

When there are a plurality of the deformable surfaces 222 with the strain sensors 203 attached, it is possible to detect strains corresponding to the inclination of the shaft S in any direction. In particular, in the torque sensor 200, the four flexure elements 221 are disposed at positions of four-fold symmetry about the X axis, so strains in all directions can be more accurately detected. The amount of deformation of the deformable surfaces 222 is detected by the plurality of strain sensors 203 as information on the force F′ acting on the shaft S. Based on the detected strain, it is possible to calculate information on components x₁ and y₁ in two orthogonal directions of the force F′ acting on the shaft S in the radial direction.

The torque sensor 200 has a simple configuration including the holder 201, the first bearing 202, and the strain sensors 203, does not have a detection coil or the like required when a magnetostrictive sensor is used, around the shaft S, thus making the size of the device smaller. Furthermore, processing such as adherence of a magnetic layer to the shaft S is not necessary, enabling easy manufacturing.

In the torque sensor 200, the flexure element 221 (outer peripheral member 220) opposes the holding part 210 in the radial direction across the gap 240. As a result, in the torque sensor 200, the deformable surface 222 of the flexure element 221 is easily deformed, and thus stress can be detected with high sensitivity.

In the torque sensor 200, since the recess part 212 is formed, the thickness in the vicinity of the end part of the holding part 210 at the other side in the axial direction (the arrow b direction) is reduced, and thus the contact part 211 is easily elastically deformed toward the other side in the axial direction (the arrow b direction). As a result, even when a preload is applied to the first bearing 202 toward the other side in the axial direction (the arrow b direction), the contact part 211 is elastically deformed, making it possible to absorb the influence of the preload. Accordingly, in the torque sensor 200, the preload applied to the first bearing 202 is prevented from appearing as a strain of the deformable surfaces 222, and the strain sensors 203 can detect the stress with high sensitivity.

Next, a part (the sensor 100 configured to detect information (rotation angle) on a position of the shaft S) at one side in the axial direction (the arrow a direction) with respect to the torque sensor 200 in the sensor device 1 will be described. As described above, the sensor 100 includes the second bearing 101 having the inner peripheral surface 101a and the outer peripheral surface 101b, and the strain gauges 102 attached to the outer peripheral surface 101b of the second bearing 101 via the holder 201.

An eccentric member 103 having a size in the axial direction equal to or substantially equal to the size in the axial direction of the second bearing 101 is disposed between the inner peripheral surfaces 101a of the second bearing 101 and the shaft S. The eccentric member 103 makes the second bearing 101 and the shaft S eccentric to each other. In other words, the eccentric member 103 makes the second bearing 101 eccentric with respect to the shaft S.

The eccentric member 103 is a member having a columnar shape extending in the axial direction, and has a through hole (hole part) having a columnar shape having an inner diameter equal to or substantially equal to the outer diameter (diameter) of the shaft S. That is, the eccentric member 103 is an annular member. With respect to the eccentric member 103, the central axis of the outer peripheral surface (a surface at one side in the radial direction) does not coincide with the central axis of the inner peripheral surface (a surface at the other side in the radial direction). Therefore, the eccentric member 103 has a part 103a having a maximum thickness in the radial direction (hereinafter, referred to as a maximum thickness part) and a part 103b having a minimum thickness in the radial direction (hereinafter, referred to as a minimum thickness part).

The shaft S is adhered or press-fitted to the inner peripheral surface (surface at the inner side in the radial direction) of the eccentric member 103 at the part S2 supported by the second bearing 101. Thus, the shaft S is integrally fixed to the eccentric member 103. The inner ring 101i of the second bearing 101 is adhered or press-fitted to the outer peripheral surface (surface at the outer side in the radial direction) of the eccentric member 103. Thus, the inner ring 101i of the second bearing 101 is fixed to the eccentric member 103. With the above configuration, since the X axis being the central axis of the shaft S is shifted from the central axis Y of the eccentric member 103 and the second bearing 101, the second bearing 101 and the shaft S have an eccentric positional relationship with each other.

Four parts (hereinafter, referred to as plate parts) 141 stand toward one side in the axial direction (the arrow a direction) at the end surface of the holding part 210 of the holder 201 at one side in the axial direction (the arrow a direction). The four plate parts 141 are disposed at the positions of four-fold symmetry about the X axis at one side of the second bearing 101 in the radial direction (the arrow c direction). In the circumferential direction, the four plate parts 141 are disposed at the positions corresponding to the four flexure elements 221. Each of the plate parts 141 is in contact with the outer peripheral surface 101b of the second bearing 101 via a tip part 145a of the transmission part 145 to be described below at the other side in the radial direction (the arrow d direction). Note that the second bearing 101 is disposed at one side in the axial direction (the arrow a direction) with respect to the end surface of the holding part 210 at one side in the axial direction (the arrow a direction).

Each of the plate parts 141 holds the strain gauge 102. That is, the sensor 100 includes a total of four strain gauges 102 including a first strain gauge 102a held by a first plate part 141a, a second strain gauge 102b held by a second plate part 141b, a third strain gauge 102c held by a third plate part 141c, and a fourth strain gauge 102d held by a fourth plate part 141d, in the clockwise direction in plan view.

Two strain gauges 102 adjacent to each other in the circumferential direction, for example, the first strain gauge 102a and the second strain gauge 102b, are disposed at symmetrical positions with respect to a plane including the X axis. In the sensor 100, the angle formed by the direction from the X axis toward the first strain gauge 102a and the direction from the X axis toward the second strain gauge 102b is 90°. However, the angle may not be 90°. Since all the four plate parts 141 have the same configuration, only one plate part 141 will be described in detail below, and detailed description of the other plate parts 141 will be omitted unless necessary.

The recess part 144 having a cross section in a semicircular shape extending in the tangential direction or the circumferential direction is formed at a surface of the plate part 141 at the other side in the radial direction (the arrow d direction). The recess part 144 is formed in the vicinity of an end part of the plate part 141 at the other side in the axial direction (the arrow b direction). The part of the plate part 141 with the recess part 144 formed is thin, forming a deforming part 142 being deformed with a strain. The strain gauge 102 is attached to a surface at one side of the deforming part 142 in the radial direction (the arrow c direction). Deformation with a strain of the deforming part 142 can be detected as a change in a resistance value of the strain gauge 102. An opening part 141h serving as a circular hole penetrating in the radial direction is formed at a central part of the plate part 141 in the tangential direction or the circumferential direction and at one side in the axial direction (the arrow a direction) with respect to the recess part 144. A transmission part 145 having a pin-like outer shape is inserted into the opening part 141h. The transmission part 145 is fixed to the opening part 141h by bonding or press-fitting.

The transmission part 145 has a pointed tip part 145a. The transmission part 145 is disposed such that the tip part 145a protrudes further to the other side in the radial direction (the arrow d direction) with respect to the plate part 141. The outer peripheral surface 101b of the second bearing 101 is in point-contact with the tip part 145a of the transmission part 145. Therefore, the transmission part 145 can transmit displacement of the second bearing 101 to the plate part 141 via the tip part 145a.

In FIG. 7, the maximum thickness part 103a of the eccentric member 103 is located close to the third plate part 141c, and the minimum thickness part 103b of the eccentric member 103 is located close to the first plate part 141a. Therefore, the third plate part 141c is pressed toward one side in the radial direction (the arrow c direction) by the second bearing 101. Note that the second plate part 141b and the fourth plate part 141d adjacent to the third plate part 141c are also slightly pressed to one side in the radial direction (the arrow c direction) by the second bearing 101.

Therefore, in FIG. 7, the deforming part 142 of the third plate part 141c is deformed with the largest strain, and one side of the third plate part 141c in the axial direction (the arrow a direction) is warped toward one side in the radial direction (the arrow c direction). The deforming parts 142 of the second plate part 141b and the fourth plate part 141d adjacent to the third plate part 141c are deformed with a slight strain. The deforming part 142 of the first plate part 141a is not deformed with the largest strain or is not deformed with a strain at all.

When the shaft S rotates, the eccentric member 103 fixed to the shaft S also rotates together, and accordingly, the central axis Y of the second bearing 101 also rotates around the X axis. For example, when the shaft S rotates clockwise in plan view, the central axis Y of the second bearing 101 rotates clockwise in plan view about the axis X. When the central axis Y of the second bearing 101 rotate about the X axis by 90° clockwise in plan view from the state in FIG. 7, the deforming part 142 of the fourth plate part 141d transitions to a state of deformation with the largest strain.

As described above, in the sensor 100, each time the central axis Y of the second bearing 101 rotates about the X axis by 90° clockwise in plan view, the deforming parts 142 of the third plate part 141c, the fourth plate part 141d, the first plate part 141a, and the second plate part 141b sequentially transition to the state of deformation with the largest strain. Therefore, the rotation angle of the shaft S can be detected by the strain gauges 102 attached to each of the plate parts 141.

In the sensor device 1 according to the present embodiment, signals output from the plurality of strain sensors 203 and the sensor 100 are input to the arithmetic circuit 10, and the arithmetic circuit 10 calculates a magnitude fᵣ of the component Fᵣ in the radial direction and a magnitude fₜ of the component Fₜ in the circumferential direction, included in the information on the force F for rotating the shaft S. Thus, the sensor device 1 can calculate the information on the force F for rotating the shaft S by dividing the information into the component Fᵣ in the radial direction and the component Fₜ in the circumferential direction.

When the sensor device 1 is used for a bicycle, the force F applied to rotate the shaft S is a pedaling force applied to pedals by the feet of a rider. The component of the pedaling force F in the circumferential direction (corresponding to Fₜ) contributes to the rotation of a crank and the shaft S. In other words, the component corresponds to the driving force of the rotation of the crank and the shaft S. On the other hand, the component of the pedaling force F in the radial direction (corresponding to Fᵣ) rarely contributes to the rotation of the crank and the shaft S. In other words, the component corresponds to a loss force rarely contributing to the rotation of the crank and the shaft S. Since the sensor device 1 can calculate the magnitude fᵣ of the component Fᵣ in the radial direction and the magnitude fₜ of the component Fₜ in the circumferential direction of the pedaling force F, for example, by outputting these pieces of information from the arithmetic circuit 10 to a cycle computer, it is possible to prompt the rider to change to a more efficient pedaling manner. Furthermore, when the sensor device 1 is used for an electrically assisted bicycle or the like, outputting, to the motor drive unit, signals corresponding to the magnitude fᵣ of the component Fᵣ in the radial direction and the magnitude fₜ of the component Fₜ in the circumferential direction in the information on the pedaling force F is useful for control by the motor drive unit.

### MODIFIED EXAMPLES

Although the sensor device according to the present invention has been described above with reference to the preferred embodiment, the sensor device according to the present invention is not limited to the configurations of the embodiment described above. For example, although the sensor device 1 according to the embodiment described above has been described on the assumption that the sensor device is used for a bicycle, the sensor device of the present invention is not limited to being used for a bicycle, and may be used for a moving object or a rotating apparatus.

The sensor device 1 according to the above-described embodiment can be designed to be small as a whole due to the integrated structure of the sensor 100 and the torque sensor 200. However, in the sensor device of the present invention, the sensor for detecting information on a position of the shaft may not be structurally integrated with the holder with a plurality of strain sensors attached.

In the sensor 100 of the sensor device 1 according to the above-described embodiment, the second bearing 101 and the shaft S are attached to be eccentric to each other by using the annular eccentric member 103, but the second bearing 101 and the shaft S may be eccentric to each other by interposing a wedge-shaped member between the second bearing 101 and the shaft S without using the annular eccentric member 103.

Although the sensor 100 of the sensor device 1 according to the above-described embodiment detects information on a position of the shaft S by using the strain gauge 102, in the sensor device of the present invention, any sensor for detecting information on a position of the shaft may be adopted as long as the sensor can detect rotation angles of the shaft. For example, the sensor for detecting information on a position of the shaft may be an optical sensor using a light emitting element and a light receiving element, or may be a magnetic sensor such as a Hall sensor. The sensor for detecting information on a position of the shaft may not be a sensor in a strict sense, and may be a device capable of detecting a position of the shaft based on the number of rotations of a roller, or the like, rotating in contact with the shaft, for example. The sensor for detecting information on a position of the shaft may be disposed in the vicinity of the holder with a plurality of strain sensors attached, or may be disposed at a remote place. The sensor for detecting information on a position of the shaft may be disposed away from the shaft. For example, the sensor for detecting information on a position of the shaft may be disposed at a chain ring, a sprocket, a rear wheel, a crank or a pedal of a bicycle. Note that, in a moving object or a rotating apparatus, a sensor may be provided inside or at a side surface of a casing.

Although four strain sensors 203 are attached to the holder 201 in the sensor device 1 according to the above-described embodiment, the number of strain sensors attached to the holder in the sensor device of the present invention may be two, may be three, or may be five or more as long as the arithmetic circuit can finally calculate the magnitudes of the components in the radial direction and the circumferential direction of the information on the force applied to rotate the shaft. Although it is preferable that at least two strain sensors among the plurality of strain sensors be disposed shifted 90° in the circumferential direction, the angle of the shift may be more than 0° and less than 180°, 20° or more and 160° or less, 40° or more and 140° or less, 60° or more and 120° or less, or 80° or more and 100° or less.

In the sensor device of the present invention, a configuration of the holder with the plurality of strain sensors attached is not limited to the holder 201 of the torque sensor 200 of the sensor device 1 according to the above-described embodiment. For example, in the sensor device of the present invention, the holder with the plurality of strain sensors attached may have the configurations of the modified examples illustrated in FIGS. 8 to 16, or may further have a different configuration. Note that, in FIGS. 8 to 16, the sensor for detecting information on a position of the shaft S and the arithmetic circuit are omitted.

### First Modified Example

Hereinafter, a torque sensor 300 illustrated in FIG. 8 will be described. FIG. 8 is a cross-sectional view illustrating a state of the torque sensor 300 mounted on the shaft S and the external device 2. The torque sensor 300 has the same configuration as the configuration of the torque sensor 200 except that a holder 301 is provided instead of the holder 201. The holder 301 has the same configuration as the configuration of the holder 201 except that the holder 301 includes a holding part 310 instead of the holding part 210 and includes gaps 340 having a shape different from the gaps 240. Hereinafter, members and components having the same functions and configurations as the members and components of the torque sensor 200 are given the same reference signs, and detailed descriptions of the members and components will be omitted.

The holder 301 has a substantially square tubular shape in plan view, and includes the holding part 310 and the outer peripheral member 220. The holding part 310 is a member having a tubular shape extending in the axial direction and having an inner peripheral surface 310a having a cylindrical shape about the X axis. The holding part 310 is a member holding the first bearing 202. The outer peripheral member 220 is a member disposed at an outer side in the radial direction with respect to the holding part 310.

At the end parts of the holding part 310 at one side in the radial direction (the arrow c direction) and at one side in the axial direction (the arrow a direction), four connection parts 330 having a substantially rectangular shape in plan view protrude radially from the holding part 310 toward one side in the radial direction (the arrow c direction). The four connection parts 330 are disposed at positions of four-fold symmetry about the X axis. The flexure element 221 is connected to each of the connection parts 330.

As illustrated in FIG. 8, in the radial direction, the flexure element 221 (outer peripheral member 220) opposes the holding part 210 across the gap 340 extending in the tangential direction or the circumferential direction. The gap 340 includes a through hole (hole part) 341 having a circular or substantially circular cross section, and a slit 342 connected to the other side of the through hole 341 in the axial direction (the arrow b direction) and having a width (a width in the radial direction) narrower than a diameter of the through hole 341. In the radial direction, the dimension of the slit 342 formed at the holder 301 is smaller than the dimension of the slit 242 formed at the holder 201 illustrated in FIG. 7.

Since the through holes 341 are formed, the flexure element 221 (outer peripheral member 220) is formed with a recess part recessed toward one side in the radial direction (the arrow c direction) on the surface at the other side in the radial direction (the arrow d direction), the connection part 330 is formed with a recess part recessed toward one side in the axial direction (the arrow a direction) on the surface at the other side in the axial direction (the arrow b direction), and the holding part 310 is formed with a recess part recessed toward the other side in the radial direction (the arrow d direction) on the surface at one side in the radial direction (the arrow c direction).

The holder 301 includes a contact part 311 having an annular shape and protruding toward the other side in the radial direction (the arrow d direction), at an end part at the other side in the axial direction (the arrow b direction). In the present modified example, the contact part 311 protrudes from an end part of the holding part 310 of the holder 301 at the other side in the axial direction (the arrow b direction) to the other side in the radial direction (the arrow d direction). The contact part 311 is in contact with the end surface of the outer ring 2020 of the first bearing 202 at the other side in the axial direction (the arrow b direction). As a result, the contact part 311 supports the first bearing 202 while restricting downward movement in the axial direction.

The gaps 340 formed at the holder 301 illustrated in FIG. 8 have a simpler shape compared with the gaps 240 formed at the holder 201 illustrated in FIG. 7. In addition, a member corresponding to the recess parts 212 formed at the holder 201 illustrated in FIG. 7 is not formed at the holder 301 illustrated in FIG. 8. Therefore, the holder 301 illustrated in FIG. 8 is easier to manufacture than the holder 201 illustrated in FIG. 7.

### Second Modified Example

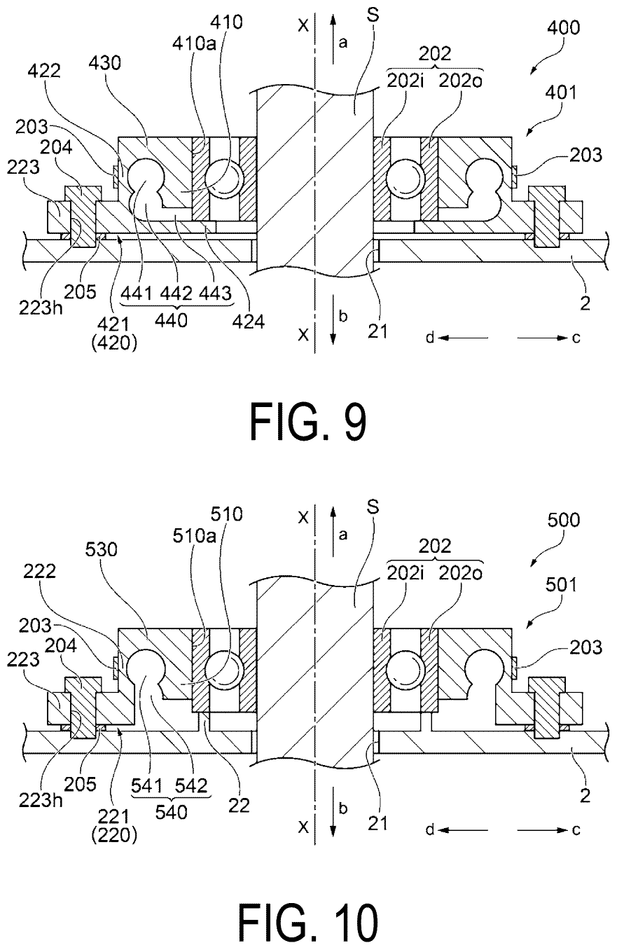

Next, a torque sensor 400 illustrated in FIG. 9 will be described. FIG. 9 is a cross-sectional view illustrating a state of the torque sensor 400 mounted on the shaft S and the external device 2. The torque sensor 400 has the same configuration as the configuration of the torque sensor 300 of the first modified example, except that a holder 401 is provided instead of the holder 301. Hereinafter, members and components having the same functions and configurations as the members and components of the torque sensor 300 of the first modified example are given the same reference signs, and detailed descriptions of the members and components will be omitted.

The holder 401 has a substantially square tubular shape in plan view, and includes a holding part 410 and outer peripheral members 420. The holding part 410 is a member having a tubular shape extending in the axial direction and having an inner peripheral surface 410a having a cylindrical shape about the X axis. The outer peripheral member 420 is a member disposed at one side (in the arrow c direction) in the radial direction with respect to the holding part 410.

In the axial direction, the dimension of the holding part 410 is smaller than the dimension of the outer peripheral member 420. In the axial direction, the end surface of the holding part 410 at one side (the arrow a direction) and the end surface of the outer peripheral member 420 at one side (the arrow a direction) are on the same plane. At the end parts of the holding part 410 at one side in the radial direction (the arrow c direction) and at one side in the axial direction (the arrow a direction), four connection parts 430 having a substantially rectangular shape in plan view protrude radially from the holding part 410 toward one side in the radial direction (the arrow c direction). The four connection parts 430 are disposed at positions of four-fold symmetry about the X axis.

A flexure element 421 having a rectangular shape in plan view and a substantially inverted T-shape in a side view is connected to each of the connection parts 430. The flexure elements 421 are deforming parts deformed by receiving stress, and are elastically deformed or plastically deformed by receiving stress. Four flexure elements 421 form the outer peripheral members 420 in the present embodiment. Since all the four flexure elements 421 have the same configuration, only one flexure element 421 will be described in detail below, while detailed description of the other flexure elements 421 will be omitted.

The flexure element 421 (outer peripheral member 420) has a deformable surface 422 extending in the axial direction. The holder 401 includes a gap 440, to be described later, between the deformable surface 422 and the holding part 410 on the first bearing 202 side with respect to the deformable surface 422. Due to the shape of the gap 440, the deformable surface 422 has a smaller thickness (thickness in the radial direction) than other parts of the flexure element 421 (outer peripheral members 420), and deformation with a strain is likely to occur.

As illustrated in FIG. 9, in the radial direction, the flexure element 421 (outer peripheral member 420) opposes the holding part 410 across the gap 440 extending in the tangential direction or the circumferential direction. The gap 440 includes a first through hole (hole part) 441 having a circular or a substantially circular cross section, a second through hole (hole part) 442 connected to the other side of the first through hole 441 in the axial direction (the arrow b direction) and having a diameter equal to or slightly less than a diameter of the first through hole 441, and a slit 443 extending from the end part of the second through hole 442 at the other side in the axial direction (the arrow b direction) to the first bearing 202 toward the other side in the radial direction (the arrow d direction).

Since the first through hole 441 is formed, the flexure element 421 (outer peripheral member 420) is formed with a recess part recessed toward one side in the radial direction (the arrow c direction) at the surface in the other side in the radial direction (the arrow d direction), the connection part 430 is formed with a recess part recessed toward one side in the axial direction (the arrow a direction) on the surface at the other side in the axial direction (the arrow b direction), and the holding part 410 is formed with a recess part recessed toward the other side in the radial direction (the arrow d direction) at the surface in one side in the radial direction (the arrow c direction).

Since each flexure element 421 has the deformable surface 422, the holder 401 of the torque sensor 400 has a plurality of (four in the present modified example) deformable surfaces 422 as a whole. The plurality of deformable surfaces 422 are disposed side by side at the positions of four-fold symmetry in the circumferential direction).

The strain sensor 203 is attached to one side of each deformable surface 422 in the radial direction (the arrow c direction). Since the strain sensor 203 is attached to each of the plurality of deformable surfaces 422, a plurality of (four in the present modified example) strain sensors 203 are attached to the torque sensor 400. The deformable surfaces 422 and the strain sensors 203 each extend along a plane parallel to the axial direction. The strain sensors 203 are attached so as to be capable of detecting a strain of the deformable surfaces 422. Thus, the strain sensor 203, when being a strain gauge, is attached to the deformable surface 422 so as to align a grid orientation (typically, the longitudinal direction of the strain gauges) to the axial direction. When the strain sensor 203 is a strain gauge, a strain of the deformable surface 422 is detected as a change in a resistance value. Directions of strains detected by the respective strain sensors 203 are different from each other.

The holder 401 includes a contact part 424 having a plate shape protruding toward the other side in the radial direction (the arrow d direction), at an end part at the other side in the axial direction (the arrow b direction). In the present modified example, the contact part 424 protrudes from the end part of the flexure element 421 (outer peripheral member 420) of the holder 401 at the other side in the axial direction (the arrow b direction) toward the other side in the radial direction (the arrow d direction). The contact part 424 opposes the holding part 410 in the axial direction across the slit 443. The dimension of the contact part 424 in the tangential direction or the circumferential direction is the same as the dimension of the flexure element 421 in the tangential direction or the circumferential direction. However, the contact part 424 may be formed in an annular shape about the X axis. The contact part 424 is in contact with the end surface of the outer ring 2020 of the first bearing 202 at the other side in the axial direction (the arrow b direction). As a result, the contact part 424 supports the first bearing 202 while restricting downward movement in the axial direction.

In the present modified example, since the contact part 424 is not provided at the holding part 410, it is possible to suppress the influence of the preload on the first bearing 202 in the axial direction from being transmitted to the deformable surface 422 via the connection part 430.

### Third Modified Example

Next, a torque sensor 500 illustrated in FIG. 10 will be described. FIG. 10 is a cross-sectional view illustrating a state of the torque sensor 500 mounted on the shaft S and the external device 2. The torque sensor 500 has the same configuration as the configuration of the torque sensor 300 of the first modified example, except that a holder 501 is provided instead of the holder 301. The holder 501 has the same configuration as the configuration of the holder 301 of the first modified example except that a holding part 510 is provided instead of the holding part 310 and the gap 340 is replaced with a gap 540 having a different shape. Hereinafter, members and components having the same functions and configurations as the members and components of the torque sensor 300 of the first modified example are given the same reference signs, and detailed descriptions of the members and components will be omitted.

The holder 501 has a substantially square tubular shape in plan view, and includes the holding part 510 and the outer peripheral member 220. The holding part 510 is a member having a tubular shape extending in the axial direction and including an inner peripheral surface 510a having a cylindrical shape about the X axis. The dimension of the holding part 510 in the axial direction is smaller than the dimension of the outer peripheral member 220. The end surface of the holding part 510 at one side (the arrow a direction) and the end surface of the outer peripheral member 220 at one side (the arrow a direction) in the axial direction are on the same plane. At the end parts of the holding part 510 at one side in the radial direction (the arrow c direction) and at one side in the axial direction (the arrow a direction), four connection parts 530 having a substantially rectangular shape in plan view protrude radially from the holding part 510 toward one side in the radial direction (the arrow c direction). The four connection parts 530 are disposed at positions of four-fold symmetry about the X axis. The flexure element 221 is connected to each of the connection parts 530.

As illustrated in FIG. 10, in the radial direction, the flexure element 221 (outer peripheral member 220) opposes the holding part 510 across gaps 540 extending in the tangential direction or the circumferential direction. The gap 540 includes a through hole (hole part) 541 having a circular or substantially circular cross section, and a slit 542 connected to the other side of the through hole 541 in the axial direction (the arrow b direction) and having a width (a dimension in the radial direction) narrower than a diameter of the through hole 541. The slit 542 is widened so that the cross section is widened in an arc shape toward the other side in the radial direction (the arrow d direction) while extending toward the other side in the axial direction (the arrow b direction).

Since the through holes 541 are formed, the flexure element 221 (outer peripheral member 220) is formed with a recess part recessed toward one side in the radial direction (the arrow c direction) at the surface in the other side in the radial direction (the arrow d direction), the connection part 530 is formed with a recess part recessed toward one side in the axial direction (the arrow a direction) on the surface at the other side in the axial direction (the arrow b direction), and the holding part 510 is formed with a recess part recessed toward the other side in the radial direction (the arrow d direction) at the surface in one side in the radial direction (the arrow c direction).

The external device 2 is fixed with a protruding part 22 formed in an annular shape about the X axis and protruding to one side in the axial direction (the arrow a direction) toward the first bearing 202. However, the protruding part 22 may be a plurality of convex parts disposed on a circumference about the X axis. The protruding part 22 is in contact with the end surface of the first bearing 202 at the other side in the axial direction (the arrow b direction). As a result, the protruding part 22 supports the first bearing 202 while restricting downward movement in the axial direction. More specifically, in the axial direction, the protruding part 22 supports the first bearing 202 by being in contact with the end surface of the outer ring 2020 at the other side in the axial direction (the arrow b direction).

In the present modified example, since the protruding part 22 supports the first bearing 202 in the axial direction, it is possible to suppress the influence of the preload on the first bearing 202 in the axial direction from appearing as a strain of the deformable surfaces 222.

### Fourth Modified Example

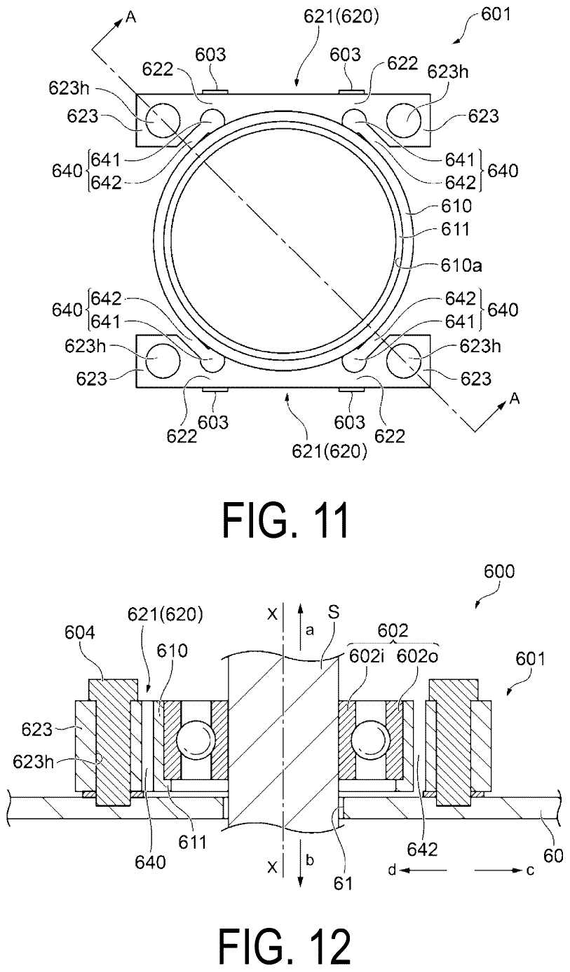

Next, a holder 601 and a torque sensor 600 illustrated in FIGS. 11 and 12 will be described. FIG. 11 is a plan view of the holder 601 and strain sensors 603. FIG. 12 is a cross-sectional view illustrating a cross section corresponding to the A-A cross section in FIG. 11 in a state of the torque sensor 600 being mounted on the shaft S and an external device 60.

The torque sensor 600 includes the holder 601, a first bearing 602, and the strain sensors 603. In the present modified example, the first bearing 602 is a ball bearing including an inner ring 602i, an outer ring 6020, and rolling elements. Note that the first bearing 602 is not limited to a ball bearing, and various other first bearings such as a sleeve bearing, for example, may be used.

The holder 601 has a substantially square tubular shape in plan view, and includes a holding part 610 and outer peripheral members 620. The holding part 610 is a member having a cylindrical shape extending in the axial direction and having an inner peripheral surface 610a having a cylindrical shape about the X axis. The outer peripheral member 620 is a member disposed at one side in the radial direction (in the arrow c direction) with respect to the holding part 610.

The dimension of the holding part 610 in the axial direction is the same as the dimension of the outer peripheral members 620. In the axial direction, the end surface at one side (the arrow a direction) and the end surface at the other side (the arrow b direction) of the holding part 610 are, respectively, on the same plane as the end surface at one side (the arrow a direction) and the end surface at the other side (the arrow b direction) of the outer peripheral members 620.

In the radial direction, two flexure elements 621 are connected to one side of the holding part 610 in the radial direction (the arrow c direction) to be mirror-symmetrical with respect to a plane including the X axis. The flexure elements 621 are deforming parts deformed by receiving stress, and are elastically deformed or plastically deformed by receiving stress. The flexure element 621 has a substantially rectangular shape with the tangential direction or the circumferential direction as a longitudinal direction, and has a shape in the central part in the longitudinal direction to about half of the dimension in the radial direction being cut off in an arc shape along the outer shape of the holding part 610. The two flexure elements 621 correspond to the outer peripheral members 620 in the present embodiment. The two flexure elements 621 have the same configuration, and thus only one flexure element 621 will be described in detail below, and detailed description of the other flexure element 621 will be omitted.

As illustrated in FIG. 11, a total of two through holes (hole parts) 641 having a circular shape or a substantially circular shape in plan view and penetrating in the axial direction are formed in the vicinities of intermediate points between the central part and each of both end parts of the flexure element 621 in the longitudinal direction, one at each intermediate point. Furthermore, the flexure element 621 is formed with two slits 642 extending to the through hole 641 in the tangential direction or the circumferential direction from the vicinity of the connection part with the holding part 610 at the surface opposing the holding part 610. A width of each slit 642 is narrower than a diameter of the through hole 641. The through hole 641 and the slit 642 constitute a gap 640.

The flexure element 621 (outer peripheral member 620) includes deforming parts 622. The region in the vicinity of the through hole 641 in the part of the flexure element 621 extending along a plane vertical in the radial direction constitutes the deforming part 622. The deforming part 622 and the holding part 610 opposes across the gap 640 in the radial direction. The deforming part 622 includes a recess part (part of the through hole 641) recessed in the radial direction at the surface opposing the holding part 610. With the presence of the through hole 641, the deforming part 622 has a smaller thickness than other parts of the flexure elements 621 (outer peripheral members 620), and deformation with a strain is likely to occur.

Since each flexure element 621 has the deforming part 622, the torque sensor 600 includes a plurality of (four in the present modified example) deforming parts 622 as a whole. In the circumferential direction, the plurality of deforming parts 622 are disposed side by side at one side of the holder 601 in the circumferential direction (the arrow c direction) (one side in the radial direction (the arrow c direction) with respect to the holding part 610).

Two strain sensors 603 are attached to a surface of each flexure element 621 extending in the axial direction and the tangential direction or the circumferential direction (deformable surface), the surface being a surface on the side opposite to the side connected to the holding part 610. The strain sensors 603 are attached to the deforming parts 622 of the flexure element 621. The deforming parts 622 and the strain sensors 603 extend along a plane extending in the axial direction and a longitudinal direction of the flexure element 621. The strain sensors 603 are attached so as to be capable of detecting a strain of the deforming parts 622 in a direction along a plane vertical to the axial direction. Accordingly, the strain sensor 603, when being a strain gauge, is attached to the deforming part 622 so as to align a grid (gauge) orientation (typically, the longitudinal direction of the strain gauges) to the longitudinal direction of the flexure element 621. When the strain sensor 603 is a strain gauge, a strain of the deforming parts 622 is detected as a change in a resistance value. Note that the strain sensor 603 is not limited to a strain gauge, and may be various other types of sensor such as a piezoelectric element.

The parts at both end sides of the flexure element 621 in the longitudinal direction with respect to the deforming parts 622 constitute fixing parts 623 connected to the external device 60. A through hole (hole part) 623h having a circular shape in plan view and penetrating in the axial direction is formed in the vicinity of the central part of the fixing part 623. As illustrated in FIG. 12, a bolt 604 inserted into the through hole 623h from one side in the axial direction (the arrow a direction) fixes the flexure element 621 to the external device 60 via a spacer 605. Thus, the holder 601 is fixed to the external device 60.

The first bearing 602 is disposed at the other side of the holding part 610 of the holder 601 in the radial direction (the arrow d direction). The first bearing 602 is held by the holding part 610 of the holder 601. An inner ring 602i of the first bearing 602 is adhered or press-fitted to an outer peripheral surface (surface at one side in the radial direction) of the shaft S having a columnar shape. Thus, the inner ring 602i of the first bearing 602 is fixed to the shaft S. An outer ring 6020 of the first bearing 602 is press-fitted to the inner peripheral surface 610a of the holding part 610 of the holder 601. The first bearing 602 rotatably supports the shaft S with respect to the holder 601. The end part of the shaft S at the other side in the axial direction (the arrow b direction) protrudes from a through hole 61 of the external device 60 to the outside of the external device 60.

The holder 601 includes a contact part 611 having an annular shape and protruding toward the other side in the radial direction (the arrow d direction) at an end part at the other side in the axial direction (the arrow b direction). In the present modified example, the contact part 611 protrudes from an end part of the holding part 610 of the holder 601 at the other side in the axial direction (the arrow b direction) to the other side in the radial direction (the arrow d direction). The contact part 611 is in contact with an end surface of the outer ring 6020 of the first bearing 602 at the other side in the axial direction (the arrow b direction). As a result, the contact part 611 supports the first bearing 602 while restricting downward movement in the axial direction.

When the torque sensor 600 is used for a bicycle, the shaft S is a crankshaft with a crank and pedals connected. When one of the pedals is stepped, a force acts on the shaft S on the pedal side to cause the shaft S to incline downward in the vertical direction, thus the first bearing 602 tends to move in the radial direction, and a part of the holder 601 is pressed toward one side in the radial direction (the arrow c direction). In the holder 601, stress is likely to concentrate in the deforming parts 622 of the flexure element 621, causing deformation with a strain to occur at the deforming parts 622. Such deformation with a strain is detected by the strain sensor 603.

### Fifth Modified Example

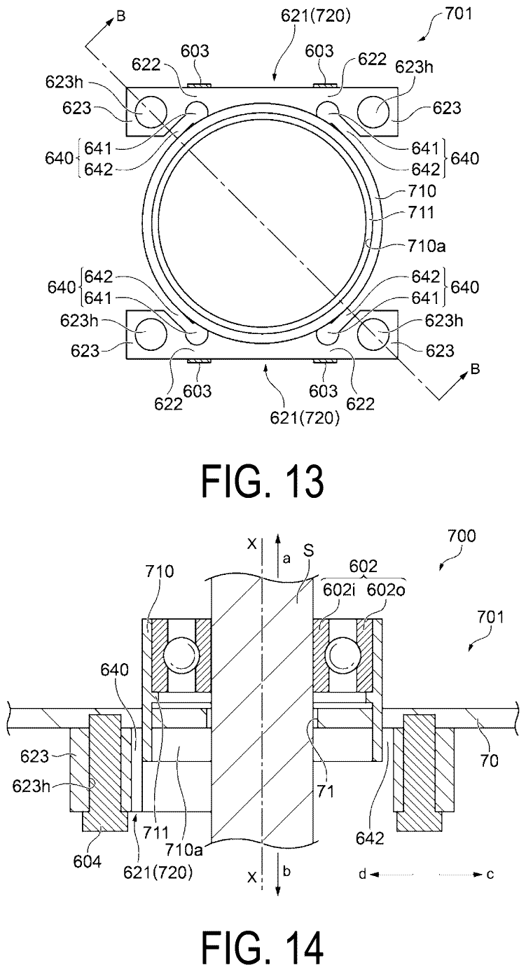

Next, a holder 701 and a torque sensor 700 illustrated in FIGS. 13 and 14 will be described. FIG. 13 is a plan view of the holder 701 and strain sensors 603. FIG. 14 is a cross-sectional view illustrating a cross section corresponding to the B-B cross section in FIG. 13 in a state of the torque sensor 700 being mounted on the shaft S and an external device 70. The torque sensor 700 has the same configuration as the configuration of the torque sensor 600 of the fourth modified example, except that the holder 701 is provided instead of the holder 601. Hereinafter, members and components having the same functions and configurations as the members and components in the fourth modified example are given the same reference signs, and detailed descriptions of the members and components will be omitted below.

The torque sensor 700 includes the holder 701, the first bearing 602, and the strain sensors 603. The holder 701 has a substantially square tubular shape in plan view, and includes a holding part 710 and outer peripheral members 720. The holding part 710 is a member having a cylindrical shape extending in the axial direction and having an inner peripheral surface 710a having a cylindrical shape about the X axis. The outer peripheral member 720 is a member disposed at one side (in the arrow c direction) in the radial direction with respect to the holding part 710. An overall configuration of the holder 701 is similar to the configuration of the holder 601 of the torque sensor 600 of the fourth modified example, but differs from the holder 601 of the torque sensor 600 of the fourth modified example in that a dimension of the holding part 710 in the axial direction is longer and the holding part 710 and the outer peripheral member 720 are connected to be shifted from each other in the axial direction.

As illustrated in FIG. 14, the dimension of the holding part 710 in the axial direction is greater than the dimension of the outer peripheral members 720. In the axial direction, the end surface at one side (the arrow a direction) and the end surface at the other side (the arrow b direction) of the holding part 710 are, respectively, disposed at one side (the arrow a direction) with respect to the end surface at one side (the arrow a direction) and the end surface at the other side (the arrow b direction) of the outer peripheral member 720. The end part of the outer peripheral member 720 at one side in the axial direction (the arrow a direction) is connected to the vicinity of the end part of the holding part 710 at the other side in the axial direction (the arrow b direction).

The holder 701 includes a contact part 711 having an annular shape and protruding toward the other side in the radial direction (the arrow d direction) slightly at one side from the central part in the axial direction (the arrow a direction). The contact part 711 is provided at one side (the arrow a direction) with respect to the end part of the outer peripheral member 720 at one side in the axial direction (the arrow a direction). In the present modified example, the contact part 711 protrudes toward the other side in the radial direction (the arrow d direction) from the vicinity of the central part of the holding part 710 of the holder 701 in the axial direction. The contact part 711 is in contact with the end surface of the outer ring 6020 of the first bearing 602 at the other side in the axial direction (the arrow b direction). As a result, the contact part 711 supports the first bearing 602 while restricting downward movement in the axial direction.

The part of the holding part 710 at the other side with respect to the contact part 711 in the axial direction (the arrow b direction) passes through the external device 70 and extends to the other side (the arrow b direction) with respect to the external device 70. The outer peripheral members 720 are disposed at the other side of the external device 70 in the axial direction (outside of the external device 70). The bolt 604 is inserted into the through hole (hole part) 623h formed at the fixing part 623 of the flexure element 621 of the outer peripheral member 720 from the other side in the axial direction (the arrow b direction).

Since the outer peripheral member 720 is disposed outside the external device 70 in the present modified example, the internal structure of the external device 70 can be more simplified, making the size of the device smaller.

### Sixth Modified Example

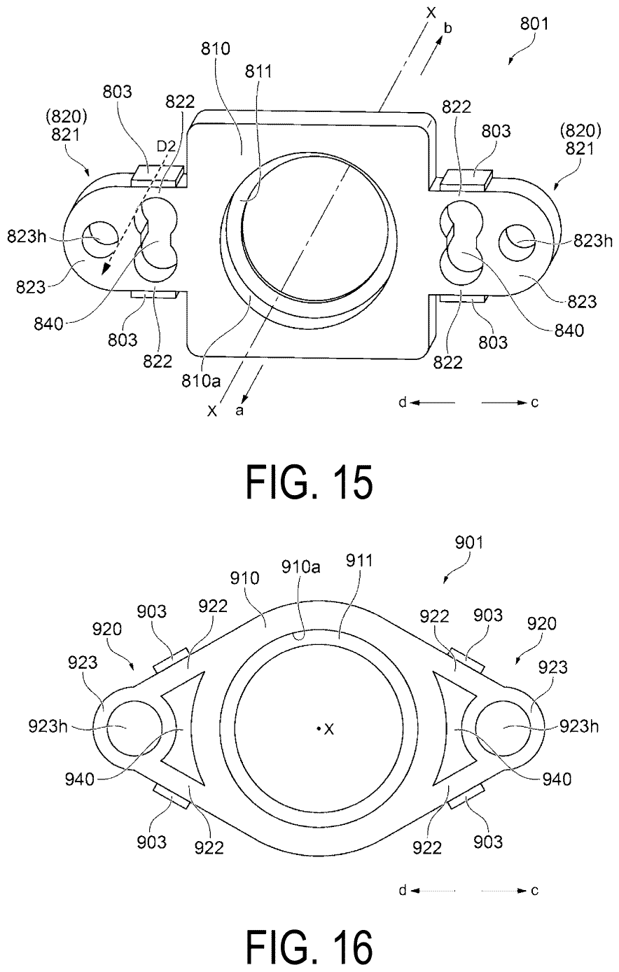

Next, a holder 801 illustrated in FIG. 15 will be described. FIG. 15 is a perspective view of the holder 801 and strain sensors 803 of the present modified example.

The holder 801 has a flat plate shape, and includes a holding part 810 and outer peripheral members 820. The holding part 810 is a plate-shaped member having a substantially square shape in plan view and including an inner peripheral surface 810a having a cylindrical shape about the X axis. The outer peripheral member 820 is a member disposed at one side in the radial direction (the arrow c direction) with respect to the holding part 810.

Of the outer peripheral surfaces (surfaces at one side in the radial direction) of the holding part 810, a flexure element 821 is connected to each central part of two surfaces opposing across the X axis. The flexure element 821 is a member extending in the radial direction as a longitudinal direction, and the end part of the member at one side in the radial direction (the arrow c direction) has a substantially semicircular shape in plan view. A dimension of the flexure element 821 in the tangential direction or the circumferential direction is smaller than a dimension of the holding part 810. The two flexure elements 821 correspond to the outer peripheral members 820 in the present modified example. The two flexure elements 821 have the same configuration, and thus only one flexure element 821 will be described in detail below, and detailed description of the other flexure element 821 will be omitted.

In the flexure element 821 (outer peripheral member 820), a through hole (gap) 840 penetrating in the axial direction is formed in the vicinity of the connection part with the holding part 810. The through hole 840 has a shape such that two holes having a circular shape or a substantially circular shape in plan view and aligned in the tangential direction or the circumferential direction are connected by a hole having a rectangular shape in plan view.

The flexure element 821 (outer peripheral members 820) includes a deforming part 822. In the flexure element 821, two parts opposing in the tangential direction or the circumferential direction across the through hole 840 constitute the deforming part 822. With the through hole 840 formed, the deforming part 822 has a smaller thickness than other parts of the flexure element 821 (outer peripheral member 820), and deformation with a strain is likely to occur. Since each flexure element 821 includes the two deforming parts 822, the holder 801 includes a plurality of (four in the present modified example) deforming parts 822 as a whole.

Two strain sensors 803 are attached to the outer peripheral surface (deformable surface) extending in the axial direction of each flexure element 821. The strain sensors 803 are attached to the deforming parts 822. The deforming parts 822 and the strain sensors 803 extend in the axial direction and a protruding direction (longitudinal direction) of the flexure element 821. The strain sensors 803 are attached so as to be capable of detecting a strain of the deforming parts 822 in a direction along a plane vertical to the axial direction.

Accordingly, the strain sensor 803, when being a strain gauge, is attached to the deforming part 822 so as to align the grid (gauge) orientation (typically, the longitudinal direction of the strain gauges) to the protruding direction (longitudinal direction) of the flexure element 821. However, the strain sensor 803 may be attached to the deforming part 822 so as to align the grid orientation to the axial direction (see the arrow D2 in FIG. 15). When the strain sensor 803 is a strain gauge, a strain of the deforming part 822 is detected as a change in a resistance value. Note that the strain sensor 803 is not limited to a strain gauge, and may be various other types of sensor such as a piezoelectric element.

One side of the flexure element 821 in the radial direction with respect to the deforming part 822 constitutes a fixing part 823 connected to an external device (not illustrated). A through hole (hole part) 823h having a circular shape is formed in the vicinity of the central part of the fixing part 823. The holder 801 can be fixed to the external device by passing bolts or the like through the through holes 823h.

A bearing (not illustrated) is disposed at the other side of the holding part 810 of the holder 801 in the radial direction (the arrow d direction). The holder 801 includes a contact part 811 having an annular shape and protruding toward the other side in the radial direction (the arrow d direction) at an end part at the other side in the axial direction (the arrow b direction). In the present modified example, the contact part 811 protrudes toward the other side in the radial direction (the arrow d direction) from the holding part 810 of the holder 801. The contact part 811 comes into contact with the end surface of the bearing at the other side in the axial direction (the arrow b direction). Thus, the contact part 811 can support the bearing in the axial direction.

When the torque sensor including the holder 801 is used for a bicycle, the shaft S is a crankshaft including pedals. When one of the pedals is stepped, a force acts on the shaft S on the pedal side to cause the shaft S to incline downward in the vertical direction, thus the bearing tends to move in the radial direction, and a part of the holder 801 is pressed toward one side in the radial direction (the arrow c direction). In the holder 801, stress is likely to concentrate on the deforming parts 822 of the flexure element 821, causing deformation with a strain to occur at the deforming parts 822. Such deformation with a strain is detected by the strain sensor 803. The holder 801 of the present modified example has a flat plate shape and is fixed to the external device only by the two fixing parts 823, simplifying the structure and achieving size and weight reduction of the device.

### Seventh Modified Example

Next, a holder 901 illustrated in FIG. 16 will be described. FIG. 16 is a plan view of the holder 901 and strain sensors 903 of the present modified example.

The holder 901 has a flat plate shape and a substantially rhombic shape in plan view, and includes a holding part 910 and outer peripheral members 920. The holding part 910 is a member having an annular shape and having an inner peripheral surface 910a having a cylindrical shape about the X axis. The outer peripheral member 920 is a member disposed at one side in the radial direction (the arrow c direction) with respect to the holding part 910.

Two fixing parts 923 having a small annular shape are disposed slightly away from the holding part 910 at positions of two-fold symmetry about the X axis at one side of the holding part 910 in the radial direction (the arrow c direction). Four deforming parts 922 having a beam shape connect the holding part 910 and the two fixing parts 923 in the vicinity of four tangential lines circumscribing the holding part 910 and the two fixing parts 923. The two fixing parts 923 and the deforming parts 922 constitute the outer peripheral members 920 in the present embodiment. A gap 940 is formed between the holding part 910 and the fixing part 923. The deforming part 922 and the holding part 910 oppose across the gap 940 in the radial direction.

The strain sensor 903 is attached to a surface (deformable surface) extending in the axial direction of each deforming part 922, the surface being a surface on the side opposite to the surface opposing the holding part 910. The deforming parts 922 and the strain sensors 903 each extend along a plane parallel to the axial direction. The strain sensors 903 are attached so as to be capable of detecting a strain of the deforming parts 922 in a direction along a plane vertical to the axial direction. Accordingly, the strain sensor 903, when being a strain gauge, is attached to the deforming part 922 so as to align the grid (gauge) orientation (typically, the longitudinal direction of the strain gauges) to the longitudinal direction of the deforming part 922. When the strain sensor 903 is a strain gauge, a strain of the deforming part 922 is detected as a change in a resistance value. Note that the strain sensors 903 are not limited to strain gauges, and may be various other types of sensor such as a piezoelectric element.

The fixing part 923 is a part connected to an external device (not illustrated). The fixing part 923 is disposed at one side of the deforming parts 922 in the radial direction (the arrow c direction). A through hole (hole part) 923h having a circular shape is formed in the vicinity of the central part of the fixing part 923. The holder 901 can be fixed to the external device by passing bolts or the like through the through holes 923h.

A bearing (not illustrated) is disposed at the other side of the holding part 910 of the holder 901 in the radial direction (the arrow d direction). The holder 901 includes a contact part 911 having an annular shape and protruding toward the other side in the radial direction (the arrow d direction) at an end part at the other side in the axial direction (the arrow b direction). In the present modified example, the contact part 911 protrudes toward the other side in the radial direction (the arrow d direction) from the holding part 910 of the holder 901. The contact part 911 comes into contact with the end surface of the bearing at the other side in the axial direction (the arrow b direction). Thus, the contact part 911 can support the bearing in the axial direction. Since the holder 901 of the present modified example can be designed to be lightweight, weight reduction of the device can be achieved.

Although various modified examples have been described above as the configurations of the holder with a plurality of strain sensors attached and the torque sensor in the sensor device of the present invention, the configurations of the holder and the torque sensor are not limited to the above-described embodiments and modified examples.

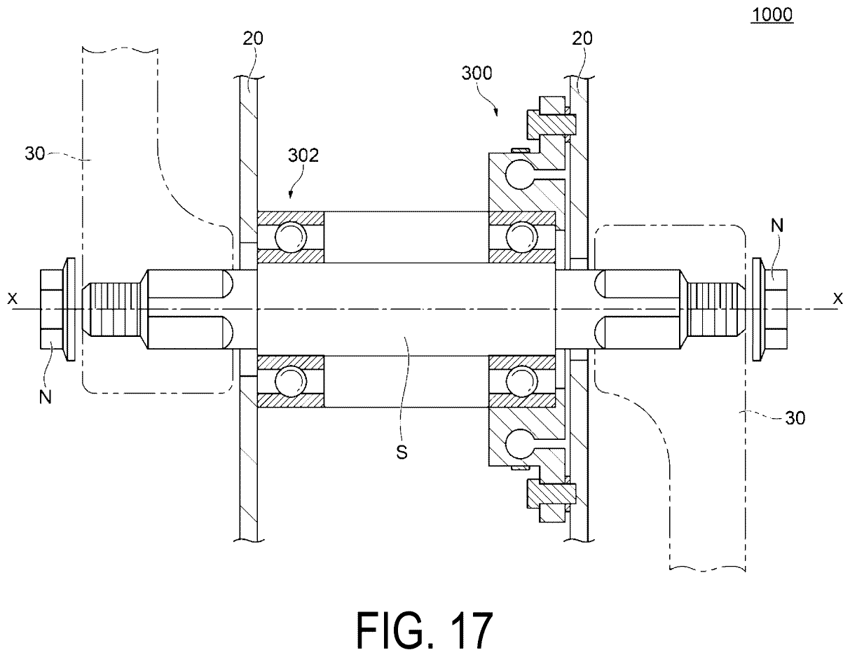

For example, FIG. 17 illustrates an example of the above-described sensor device applied to a device including a crank 30 and the shaft S used in a moving object 1000 such as a bicycle. The moving object 1000 includes the shaft S, the crank 30 fixed to the shaft S via a fixing tool N, a cover 20 covering a part of the shaft, and the above-described sensor device coupled to the cover 20. Note that, although the torque sensor 300 is illustrated in FIG. 17 for the sake of convenience, the form of the sensor device is not limited to a sensor device using the torque sensor 300. In addition, in FIG. 17, an arithmetic circuit and a sensor for detecting information on positions of the shaft S are omitted. The vicinity of the end part of the shaft S inside the cover 20 is supported by another bearing 302, the end part being located at the side opposite to the side with the torque sensor 300 disposed. An external force can act on the crank 30, and the crank 30 receiving the external force transmits a rotational force resulting from the external force to the shaft S, and the shaft S receiving the rotational force rotates. The shaft S rotating is rotatably supported by a bearing of the sensor device.

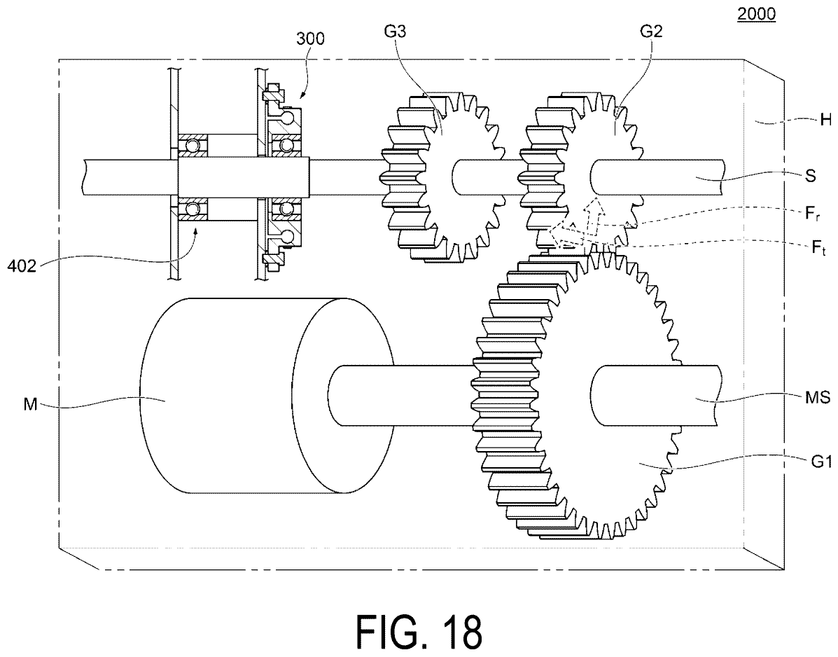

On the other hand, FIG. 18 illustrates an example of the sensor device applied to a rotating apparatus 2000 having one or a plurality of gears G1, G2, and G3 and a motor M. Note that, although the torque sensor 300 is illustrated in FIG. 18 for the sake of convenience, the form of the sensor device is not limited to a sensor device using the torque sensor 300. In addition, in FIG. 18, an arithmetic circuit and a sensor for detecting information on positions of the shaft are omitted. The rotating apparatus 2000 includes one or a plurality of gears G1, G2, and G3, and the motor M having a shaft MS coupled to the one gear G1. When the motor M is driven, the shaft MS rotates, the gear G1 fixed to the shaft MS rotates, another gear G2 meshed with the gear G1 rotates, and the shaft S fixed to the other gear G2 rotates. The shaft S fixed to the other gear G2 is rotatably supported by bearings of the sensor device described above. The sensor device is supported by a casing H of the rotating apparatus 2000. The vicinity of the end part of the shaft S at the side opposite to the side with the torque sensor 300 disposed is supported by another bearing 402.

As described above, in the moving object 1000 of FIG. 17, the external force acts on the crank 30 to rotate the shaft S, and the sensor device is applied to this shaft. In the rotating apparatus 2000 of FIG. 18, the other gear G2 meshing with the gear G1 influenced by the driving force of the motor M rotates, and the sensor device is applied to the shaft S supporting the other gear G2. In the rotating apparatus 2000 of FIG. 18, the sensor device of the present invention can calculate the magnitudes of a component Fₜ in the circumferential direction (thrust force) and a component Fᵣ in the radial direction (loss force) included in the information on the force acting from the one gear G1 to the other gear G2 (force for rotating the shaft S). As described above, the above-described sensor device can be applied to a device using the principle of leverage.

In addition, a person skilled in the art can appropriately modify the sensor device according to the present invention and change combinations of the various configurations based on previously known knowledge. Such modifications are of course included in the scope of the present invention as long as these modifications still include the configurations of the present invention.

### REFERENCE SIGNS LIST

1 Sensor device, 10 Arithmetic circuit, 100 Sensor, 201, 301, 401, 501, 601, 701, 801, 901 Holder, 202, 602 Bearing (first bearing), 203, 603, 803, 903 Strain sensor, 210, 310, 410, 510, 610, 710, 810, 910 Holding part, 222, 422 Deformable surface, 230, 330, 430, 530 Connection part, 240, 340, 440, 540, 640, 840, 940 Gap, S Shaft.

1. A sensor device comprising:
a bearing;
a shaft including a part supported by the bearing;
a holder including a holding part configured to hold the bearing and a deformable surface extending in an axial direction of the bearing;
a plurality of strain sensors configured to detect information on a force acting on the shaft;
a sensor configured to detect information on a position of the shaft in a circumferential direction of the bearing; and
an arithmetic circuit,
wherein the plurality of strain sensors are attached to the deformable surface, a signal output from the plurality of strain sensors and the sensor is input to the arithmetic circuit, and
the arithmetic circuit calculates a magnitude of a component in a radial direction of the bearing and a magnitude of a component in the circumferential direction of the bearing, the components being included in information on a force for rotating the shaft at a predetermined position of the shaft in the circumferential direction of the bearing.

2. The sensor device according to claim 1, wherein the information on a position of the shaft is a rotation angle of the shaft.

3. The sensor device according to claim 1, wherein the information on a force acting on the shaft is an amount of deformation of the deformable surface.

4. The sensor device according to claim 1, wherein
when θₐ is a rotation angle of the shaft with respect to a predetermined angle in the circumferential direction of the bearing, θ_{b} is an angle of a direction of a force for rotating the shaft with respect to the predetermined angle, and f is a magnitude of the force for rotating the shaft, the arithmetic circuit calculates a magnitude fᵣ of a component in the radial direction of the bearing and a magnitude fₜ of a component in the circumferential direction of the bearing, as fᵣ=|f×cos(θₐ−θ_{b})| and fₜ=|f×sin(θₐ−θ_{b})|, respectively, the components being included in the information on the force for rotating the shaft.

5. The sensor device according to claim 1, wherein directions of strains detected by each of the plurality of strain sensors are different from each other.

6. The sensor device of claim 1, wherein the holding part is located at a side closer to the bearing with respect to the deformable surface.

7. The sensor device according to claim 6, wherein the holder includes a connection part connecting the holding part and the deformable surface.

8. The sensor device according to claim 7, wherein
the holder includes a gap between the deformable surface and the holding part in the radial direction of the bearing, and
the connection part includes a recess part recessed in the axial direction of the bearing.
